(19) United States
(12) Patent Application Publication
(10) Pub. No.: US 2007/0219994 A1
(43) Pub. Date: Sep. 20, 2007

(54) METHODS AND SYSTEMS FOR DISPLAYING MEDIA UTILIZING USER-GENERATED DATA

(76) Inventor: Greg M. Lemelson, Southborough, MA (US)

Correspondence Address: ANTOINETTE G. GIUGLIANO, P.C., 100 Cummings Center, Suite 342G, Beverly, MA, 01915, US

(21) Appl. No.: 11/674,527

(22) Filed: Feb. 13, 2007

(51) Int. Cl. G06F 7/00

(52) U.S. Cl. 707/7

(57) ABSTRACT

The present invention includes “Discovery” methods and systems for ranking or displaying one or more media by calculating one or more functions, based on a random variable (Random Boost (RB)) and one or more of the following variables: popularity (P) of the media, recency (R) of the upload of the media, content (C) of the media, user's relationship to the poster (Friend Boost (FB)), and user's location in relation to the poster (Location Boost (LB). The results of each of the functions are summed in a weighted formula to obtain a rank for the media.

The present invention also relates to “Diversity” methods and systems that relate to ranking or displaying one or more media by comparing metadata attached to the media with a pooled set of metadata from a set of media in an environment. The method displays the media when there are shared metadata and then removes one or more pieces of the shared metadata from the pooled set. The removal of the shared metadata provides an opportunity of metadata with other tags to be displayed thereby providing a display having a more diverse set of media.

### RELATED APPLICATION

This application relates to U.S. Utility application, application No. (Not Yet Assigned; Attorney Docket No: 0053.0003-000), entitled “Social Networking and E-commerce Integration,” by Greg M. Lemelson, filed on even date herewith.

The entire teachings of the above application are incorporated herein by reference.

### BACKGROUND OF THE INVENTION

When searching for media, a user often receives a number of images, often with the most viewed/clicked displayed first. Many times, the same search will reveal the same images in the same order. Several images receive little or no viewing by users because the same popular images dominate the top spots. Displaying images in this manner provides little variety and is viewed by certain users to be uninteresting.

Accordingly, a need exists for methods for displaying a set of media that is interesting and diverse. A further need exists to rank media on factors in addition to view popularity. Yet another need exists to rank media based, in part, on a random variable in addition to user generated or user inputted data.

### SUMMARY OF THE INVENTION

The methods of the present invention relate to methods (e.g., discovery methods) of ranking one or more media in an environment for display by a user, wherein the media is uploaded by a poster (e.g., a user who uploads media). The steps of the methods include calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB)), to obtain a result for each variable calculated. The methods also encompass summing the results with a weighted formula to thereby obtain a sum. The rank of the media reflects or is a direct correlation, or function of the sum. The methods include displaying one or more media according to its rank, in descending order (e.g., the highest ranking media appears first, and then the next highest appears, as so on). The methods also encompass calculating a function based on a number of offending metadata attached to the media, to thereby obtain a blacklist penalty (BP), and subtracting the blacklist penalty from the sum. In another embodiment, the methods relate to calculating a function based on an editor's opinion of the media (Editor's Boost (EB)), and adding the result to the sum. The sum is obtained, in one aspect, by a weighted formula as follows:

Sum=W1(P)+W2(R)+W3(C)+W4(FB)+W5(LB)+W6(RB)−W7(BP)+W8(EB)

wherein W1, W2, W3, W4, W5, W6, W7, and W8 are a number. In an embodiment the weighted number ranges from 0.1-99. The greater the number the greater the weight of the variable, and the lesser the number the lesser the weight of the variable. The functions, in an aspect, are calculated using the following formulas:

P=log(# of views+1)+0.1*log(# of its tag clicks in last 24 hours+1);

R=1/sqr(# of time increments from the uploaded date to today);

C=log(# of comments+1)+0.3*log(# of tags+1)+0.1*log(size of the media file in Mega bytes+1);

FB=(1 if user is the poster's network, 0 otherwise)+(1 if the media has permission for view by poster's network and user is in poster's network, 0 otherwise);

LB=2 if user lives in the same city with the poster, 1 if one lives in the same state with the poster, or 0 otherwise;

RB=a random number between 0 and 1;

BP=# of offending tags attached to with the media; and

EB=1 if an editor's pick, 0 otherwise.

The methods include applying these steps for media uploaded a specific date, week, month or year. The display can be in calendar format.

The methods (e.g., diversity methods) of the present invention also include displaying one or more media having metadata attached thereto. The metadata from more than one piece of media in an environment are pooled. The methods include comparing the metadata attached to the media with the pooled set of metadata to determine if shared metadata exists. If shared metadata exists, then the method includes displaying said media having the attached metadata; and removing one or more pieces of shared metadata from the pooled set. If no shared metadata exists, then the method involves assigning a rank to the media, wherein the rank is a low rank (e.g., the lowest rank). The methods include displaying the media according to this rank. Additional steps include displaying the media if said media has received a change in rank. In one aspect, removing one or more pieces of metadata includes removing a piece of metadata that is popular (e.g., having the most number of views or click in a time period), or includes removing all pieces of metadata that is shared with the pooled set.

In another embodiment, the methods include displaying one or more media based on the presence, absence or content of metadata attached to the media. The metadata from more than one piece of media in an environment is pooled to thereby obtain a pooled set of metadata. If the media has an absence of metadata attached thereto, or has received a change in rank, then the media is displayed. If the media has metadata attached thereto; the method includes comparing the metadata attached to the media with the pooled set of metadata to determine if shared metadata exists. If shared metadata exists, then the method includes displaying the media having the attached metadata; and removing one or more pieces of metadata from the pooled set, as described herein. If no shared metadata exists, the method comprises assigning a rank to the media, wherein the rank is a low rank. The media is displayed according to its rank.

The methods of the present invention include displaying one or more media uploaded from a poster, based on the newness of the poster. The poster is part of a social network environment, and has joined the social network environment within a time period. The methods include comparing the time period in which the poster has joined the social network environment to a set time period. If the time period in which the poster has joined the social network environment is less than or equal to the set time period, then the media is displayed. If the time period in which the poster has joined the social network environment is greater than the set time period, then a low rank is assigned to the media. The media is displayed according to rank. If said media has received a change in rank, then the media is also displayed.

The present invention includes systems and computer apparatus for providing a display of one or more media. The system includes a source of the media in an environment for display by a user, wherein the media is uploaded by a poster; and a processor, coupled to the source. The processor carries the steps of the methods described herein. In one embodiment, the steps include calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB), to obtain a result; and summing the one or more results with a weighted formula to thereby obtain a sum. The system further includes an output device that provides a display of the media according to a rank, wherein the rank of the media is a function of the sum.

The systems and computer apparatus of the present invention also include a source of one or more media having metadata attached thereto, wherein the metadata from more than one piece of media in an environment is pooled to thereby obtain a pooled set of metadata. The systems include a processor, coupled to the source, wherein the processor carries out the steps of comparing the metadata attached to the media with the pooled set of metadata to determine if shared metadata exists. If shared metadata exists, then the method includes displaying the media having the attached metadata; and removing one or more pieces of metadata from the pooled set. If no shared metadata exists, then the method includes assigning a rank to the media, wherein the rank is a low rank. The system includes an output device that provides a display of the media according to rank.

Additionally, the present invention includes systems and computer apparatus for providing a display of one or more media by a user. The system includes a source of one or more media uploaded by a poster, wherein the poster is part of a social network environment and the poster that has joined the social network environment within a time period. The system further relates to a processor, coupled to the source, wherein the processor carries out the steps of comparing the time period in which the poster has joined the social network environment to a set time period. If the time period in which the poster has joined the social network environment is less than or equal to the set time period, then the media is displayed. If the time period in which the poster has joined the social network environment is greater than the set time period, then the processor assigns a rank to the media, wherein the rank is a low rank. The system includes an output device that provides a display of the one or more media according to rank.

The present invention provides several advantages. The methods prevent only few popular media to dominate the top display spots. Rather, the methods allow for an interesting and diverse display of media. The methods provide for a better online experience when viewing media by providing a variety of images, including images that may not otherwise be viewed. The present invention also takes advantage of a social network structure by using variables such as a friend boost (e.g., users identified as being in the poster's network and/or providing permission to users in the network to view images). Accordingly, the present invention allows users to more readily view images of users in their own network.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram employing the methods of ranking and/or displaying media, as described herein.

FIGS. 2A-E shows the source code of the discovery algorithm.

FIGS. 3A-E shows the source code of the algorithm used to rank photographs in one embodiment.

FIG. 4 is a display of photographs as determined by the source code in an embodiment.

FIG. 5 shows the source code used to generate a monthly calendar view using the present invention.

FIG. 6 is the display generated by the source code in FIG. 5.

FIGS. 7A-E is the source code used to generate a daily calendar view using the present invention.

FIG. 8 is a display generated by the source code in FIG. 7A-E.

FIG. 9 shows the database structure of an embodiment of the present invention.

FIG. 10 shows certain actual variable amounts of an embodiment of the present invention.

### DETAILED DESCRIPTION OF THE INVENTION

A description of preferred embodiments of the invention follows.

The present invention relates to methods for ranking and/or displaying digital media by employing one or more algorithms, referred to as the “Discovery” algorithm. The discovery algorithm used in the present invention allows users to view an interesting set of media that is not solely based on popularity. In addition to popularity, the methods that employ the discovery algorithm are based on one or more user generated variables and, in part, on a random factor. The Discovery algorithm assigns a rank or measurement (e.g., the “Discovery” rank or “Discovery” measurement) to each piece of media in the group and the methods of the present invention include displaying the media according to the rank (e.g., from highest to lowest or in descending order). Methods utilizing the discovery algorithm are referred to herein as the “discovery methods.” A rank refers to a number given to an individual media to provide an order within a set of media.

The present invention further includes ranking media for providing a diverse set of media, which is accomplished in part by an algorithm referred to as the “Diversity” algorithm and results in a “Diversity” measurement or “Diversity” rank of the media. In particular, providing a diverse set of images includes, in an embodiment, providing images that have not been widely viewed by users, the steps of which are further described herein. The methods that employ the diversity algorithm ranks images based on the metadata associated with a piece of media, as compared to a pooled set of metadata (e.g., metatags or tags) for a plurality of media in an environment, and then removing metatags shared from the pooled set. The removal of the shared tags from the pooled set provides an opportunity for media with other tags to be displayed. The methods using the diversity algorithm are referred to herein as the “Diversity methods.”

In an embodiment, the Diversity methods are executed after the Discovery methods are performed, e.g., as a post-processor routine. However, the discovery methods and the diversity methods can be used in no specific order, or independent of one another.

In an embodiment, the data used when employing the steps of present invention include data that are input or generated by one or more users (e.g., including posters, a user that uploads media), or is otherwise described herein as “wiki” data. Several variables used in the discovery or diversity algorithms are based on user generated or user inputted data. Wiki-based data refer to data built upon a user's input, and preferably built upon multiple users' input. Metadata is an example of user generated data. In particular, data entered by the user and attached to a piece of media such as text, an image, a video, or combination thereof, is referred to herein as “metadata” or “metatags.” Media is defined herein as a file that contains one or more images, video, movie, and/or audio data. Media can be made up of one or more files that are in any format now known e.g., jpeg, pdf, tiff, avi, .mov, .mpg, mp3, mp4, .png, gif, psd, and the like or developed in the future. Specifically, media includes streaming video, a series of associated movie files, and any format that includes a series of frames. Often metadata can be viewed when the user places their mouse over the object to which the data is attached. Users can attach data to various media to provide a library, index or database of metadata along with the media to which they are associated. “User inputted data” and “user generated data” are used interchangeably, herein, and refer to data input by one or more users, as well as data generated based on actions of one or more users. In particular, user inputted data are data that are generated by the user currently viewing the media, users that have viewed the media at a prior time point, users that associate metadata to the media, users associated with or part of the network of the site or environment. In an embodiment, combinations of user generated and non-user generated data are used.

Such data are entered and viewed using a graphical user interface (GUI), or an interface known in the art, or later developed. Software that can be used to create, in part or in whole, such an interface includes, e.g., AJAX (Asynchronous Java and XML) software, DreamWeaver, and FLASH software, javascript, php, css, asp, cold fusion, jsp ruby, ruby on rails, and the like. An interface refers to any mechanism by which an external user or computer can obtain and provide data.

In an embodiment, once the user requests media to be displayed on, e.g., a screen via a GUI or email, the present invention is employed. The user can conduct a search, or simply click on a link to access a display of media. A “display” of media refers the appearance of one or more media or objects to which user generated data can be attached or associated. In an embodiment, a display is a series (e.g., plurality) of photographical images having metadata attached thereto. In an example, a user performs a search on “dogs” and obtains a series of pictures having metadata that includes dogs (or variations thereof). The methods of searching include a direct hit search, or searches that include hits with similar words (e.g., plurals, synonyms, word variations, etc.). Prior to the present invention, the user would often obtain the most popular photographs first. The most popular refers to those clicked on or viewed most, in an environment. This results in the same images or media being viewed over and over with little variety.

The present invention utilizes an algorithm to obtain the discovery measurement assigned to each piece of media which in turn determines which media is viewed by the user first, or appears first on the screen. The discovery algorithm (i.e., the algorithm used to determine the discovery measurement) is as follows:

DR=W1(P)+W2(R)+W3(C)+W4(FB)+W5(LB)+W6(RB)−W7(BP)+W8(EB)

wherein parameters W1-W8 are numbers that assign a weight (e.g., a number) to each variable, and the weight assigned can vary as desired based on their importance to the site utilizing algorithm. For example, if the site utilizing the algorithm values one variable over another, then a weight can be assigned accordingly. The greater the number, the greater the weight that is assigned to the variable, and the lesser the number the lesser is the weight of the variable. In an embodiment, the weights were assigned as follows: W1=0.25, W2=5, W3=10, W4=3, W5=3, W6=0.1, W7=30, and W8=15. These weights can range in an amount between about 0.1 to about 99. However, if the site using the algorithm values a FB (Friend Boost) more than C (Content), both defined below, then the user can assign a greater weight to FB, e.g., 10 than C, e.g., 2. Another major advantage of the discovery algorithm is that it is very difficult to spam (e.g. small group of users trying to alter the display of results because the algorithm has depth, complexity and/or wide range of factors)
The variables, in an embodiment, are defined as follows:

P(Popularity)=log(# of views+1)+0.1*log(# of its tag clicks in last 24 hours+1)

R(Recency)=1/sqr(# of days from the uploaded date to today)

C(Content)=log(# of comments+1)+0.3*log(# of tags+1)+0.1*log(size of the photo file in Mega bytes+1)

FB(Friend Boost)=friend photo (1 if one is the poster's friend, 0 otherwise)+friend permission (1 if the photo has a “friend” permission and one is the poster's friend, 0 otherwise)

LB(Location Boost)=2 if one lives in the same city with the poster, 1 if one lives in the same state with the poster, or 0 otherwise.

RB(Random Boost)=a random number between 0 and 1

BP(Blacklist Penalty)=# of offending tags associated with the photo

EB(Editorial Boost)=1 if an editor picks it 0 otherwise

These variables are a function of one or more data elements (e.g., data used to compute the function). For example, the Popularity variable is a function of the number views by users of the media, as well as the number of clicks/views of the associated metadata. The Popularity variable can be limited by a time period in which the views of the media and/or metadata occur. The time period in which the number of clicks/views are measured can vary depending on the amount of traffic on the site. Such a time period can be any time period and includes hours, days, weeks, months, and years. In an embodiment, the time period for measuring popularity ranges range between about 1 hour and about 1 week (e.g., 1 day, 2 days, 3 days, etc.). To obtain a set of media that does not predominately contain the most clicked/viewed media, the weight of the popularity variable can be given a low weight, as shown in the above example.

The Recency variable is a function of the number of days that have passed since a user uploaded the media. Depending on the type of site and amount of users uploading media, recency can be relative, and can be measured in any measurement of time including, hours, days, weeks, months, and years. Preferably, recency is measured by the number of days from the date of uploading. Since a zero value would nullify the recency function, the day of upload is assigned a value of “1”, and increase by the number of days from there. For example, a photograph updated 2 days ago is assigned a value of “3.”

Content of the media is yet another variable of the discovery algorithm. The content function is based on the number of user generated comments, the number of metadata (e.g., metatags) and the size of the media file. The number of user generated comments (e.g., comments about the media) and the number of metatags indicates not only that the media is popular, but that it is liked or disliked enough to generate user generated text. The size of the file relates to the quality of the file. A larger file size correlates with the assumption that the media is of a better quality, than a smaller file. A content variable, in an embodiment, can contain any combination of the number of comments, the number of metadata sets, and file size when executing the discovery algorithm.

Elements of the discovery algorithm relate to the social network to which the user belongs, and the permission users of the network provide. Referred to herein as a “Friend Boost,” this variable is a function of whether the user viewing the media is identified as a “friend” in the poster's (e.g., the person posting the media) network. This function is also influenced by whether the user has permission by the poster to view the photograph. Being part of the poster's network, being identified as a friend, and being given permission to view the media increases the weight assigned to the media. Conversely, the absence of any of these elements of the variable decreases the overall weight assigned to the media. Any combination of these elements can be used in the Friend Boost variable of the discovery algorithm.

The locations (Location Boost) of the user and the poster also impact the rank of the media. In an embodiment, the algorithm gives more weight to the media if the user and the poster live in the same city, as compared to an intermediate weight in the case the user and the poster live in the same state. No weight is given otherwise. The location boost of the algorithm can be varied for any type of geographical categories, including, for example, by neighborhood, city, county, area, state, regions of a country, country, and continent. Location can also be meant to include type of terrain, such as a beach, mountains, suburbs, city, rural, etc. The location boost variable can also be used to give weight to users living within a certain number of miles of the poster of the media (e.g., 1, 5, 10, 15, . . . 100 miles, etc.). This variable utilizes any function of associating the poster's location with that of the user's and is encompassed by the discovery methods.

Another aspect of the discovery algorithm includes a random function (referred to in the algorithm as “Random Boost”). The random function provides even more variety of media viewed by users. The same search repeated twice will provide for a different set of media, or different ranking of the media. This occurs, in part, because the media is assigned an arbitrary number, e.g., by the software. Depending on the extent of variety of the media desired, the random boost weight can be increased or decreased.

The discovery algorithm further embodies a penalty for having offending metadata associated with the media, and is referred to as the “Blacklist Penalty.” Certain words and phrases are known and flagged as offensive. The metadata can be scanned for such words, or combination of words. The greater number of offensive words, the greater number the blacklist penalty becomes. This amount conversely affects the overall weight of the media. In addition to offensive words, users having a history of listing offensive media can also be part of the blacklist penalty variable. In one aspect, the blacklist penalty is a function of the number of offending metatags associated or attached to the media.

Yet another variable that impacts the discovery algorithm is an Editorial Boost. The editorial boost refers to the “editor's” preference of the media. An editor is a person or group of persons that maintain, run, manage or are otherwise associated with managing the environment in which the algorithm is being executed. The editor's pick can reflect a theme, or new, interesting, or unique media. In an embodiment, the editorial boost is assigned a 1 if it is the editor's pick, and 0 if it is not.

The discovery algorithm of the present invention uses any combination of these user generated variables so long as at least one user generated variable is used in addition to the random boost, blacklist penalty, or the editorial boost. In the case in which a variable is removed from the algorithm, the weighted algorithm would delete the weight relating to that variable, and assign the remaining variables greater weight, as desired. Any combination of these variables can be used, and each variable can be modified by using suitable or similar substitutes. Moreover, any element or user generated/inputted data can be used in such variables of the discovery algorithm. Furthermore, elements can be substituted or modified (e.g., use some or additional elements of the variable) so long as the overall spirit of the variable is maintained.

Other variables can be used in such an algorithm, and include, a hit or miss algorithm, also referred to as a “voting measure.” In an embodiment, the voting measure is:

WR=WR=(V/(V+M))*R+(M/(V+M))*C

wherein, WR=Weighted Rating; R=Average Rating (arithmetic mean); V=Number of ratings given; M=Minimum number of ratings needed; C=Arithmetic mean rating across the environment (e.g., the whole site).

This variable involves users' input, namely to rate the media or what the media represents (e.g., a product shown in the media). The rating can be in any format including letters (A, B, C, etc.), symbols or numbers. The rating is converted to a number in a numerical range that can be used by the hit or miss algorithm. A rating, in an embodiment, can be a number between 1 and 10. The algorithm assigns a weight to the media based on the rating, the number of ratings received, the minimum number of ratings assigned by the site, and the mean rating for the site, as shown above. The application of this algorithm can be applied independent of the Discovery measure, or as an additional weight or component of the Discovery algorithm.

The hit or miss algorithm reduces the rank of media or products that occupy the top spot and have only a few high ratings, and increases the rank of media or products that may have a lower mean but more reviews. This algorithm is more representative of the popularity of the media when looking at users or the site as a whole.

The hit or miss variable/algorithm can be further modified by a recency factor. The weighted variable can be multiplied by a factor that depends on how recent the upload of the media occurred. In an embodiment, the weighted hit or miss variable is modified as follows:

Modified WR=WR*Recency

In an embodiment, Recency is a number between 0 and 1 depending on the date of the upload of the media or the product introduction. Recently uploaded photos or video or recently introduced products can get preference as they usually attract user's attention and yet do not have a lot of ratings. In this embodiment, the Recency variable for media is implemented as follows: divide the exiting time frame of all photos from newest to oldest into 5 equally spaced slots. The recent media in the first slot get 1.0, the media in the second slot get 0.9, the third slot 0.8, the fourth slot 0.7, and the old media in the last slot get 0.6. The Recency variable can be a numerical designation providing a higher number to the newer or more recently uploaded media, and a lower number to a older or less recently uploaded media.

Additionally, the discovery algorithm can be performed for images uploaded for a specific day, as compared with images in the entire system. Rather than ranking all media of the metadata for a plurality of images (e.g., all images) in the environment, images can also be ranked based on a specific upload date. A user can select a date, and images can be displayed for that date in accordance with the discovery or diversity methods described herein. The output of the display is further described herein and can be displayed in a calendar format (e.g., a daily, weekly, or monthly calendar).

The present invention further includes methods for displaying a diverse set of media using the diversity methods of the present invention. In particular, the diversity methods are used to present or display media so that less popular, more interesting media are displayed first/ranked first. The diversity methods of the present invention involve pooling the metadata from all of the media (e.g., all media in the environment, for a specific time point). The methods involve comparing the metadata of the instant media with that of the pooled metadata from all images of the set, and displaying the media having metadata shared with the pooled metadata. The methods include removing one or more pieces of shared metadata from the pooled set once media is displayed. The removal of the metadata from the pool provides the opportunity for less popular images to then be displayed.

In particular, the diversity methods involve the following steps. In an embodiment, the diversity methods begin with providing the media in a decreasing order of ranking (e.g., as ranked by the discovery methods described herein). Pooled metadata is defined as a set of metadata from all images in an environment. If the media has no metadata (e.g., a null set), then the media is displayed. The absence of metadata refers to media without any metadata attached thereto. The presence of metadata refers to media having metadata attached thereto, which can be shared to unshared with the pooled set of metadata. If the metadata of the instant media shares metadata from the pool (e.g., the content of the metadata is in part the same), then the media is displayed and the most popular (e.g., most clicked) shared piece of metadata is removed from the pooled set of metadata. The removal of the metadata from the pool make it harder for media to be displayed based on that piece of metadata. In the event that the media has no shared pieces of metadata with the pool, then the media is moved to the bottom of the ranking (e.g., assigned a low rank). A low rank is a rank in which the instant media is ranked less than the majority of the ranked media, and in some embodiments, a low rank is the lowest rank, as compared to the rest of the ranked media. The steps of the methods include displaying media if the media has already been moved (e.g., received a change in rank) at least once.

This algorithm for this embodiment, as applied to images, is as follows: Set A is defined as a set containing all existing tags in the system and an Image i has a set of tags defined as set Bi.
1. For each Image i in the decreasing order of ranking
2. If the Image has no tags (i.e., Bi is empty), display it.
3. If the Image has tags and there are tags shared between A and Bi, display it and remove the most clicked shared tag from A.
4. If the Image has tags and there are no tags shared between A and Bi, move it to the bottom of the ranking.
5. If the Image has already been moved once, display it.

The diversity methods and algorithm can be varied in a number of ways. For example, the order of the steps can be changed, or some can be excluded. One variation of the steps begins by putting the media in decreasing the order of the ranking. Media is displayed to the user when the metadata of the media and the pooled metadata are shared. All of the shared tags are removed from the pooled set of metadata. If there are no shared tags between the metadata of the media and the pooled metadata, then the media receives a low ranking (e.g., moved to the bottom of the ranking). In the event that the media has already been moved once (e.g., received a different rank), then the media is displayed. When comparing this variation with that above, step 2 above has been removed. Also, instead of removing the most popular shared tags, all shared tags are removed in this variation.

Methods of the present invention also include increasing or decreasing the ranking of the media based on the status of the poster (e.g., the user that uploads the media). In this embodiment, the methods begin with the media in decreasing order of ranking, and encompass displaying the media if the poster of the media is new to the networking environment, e.g., joined within a certain time period. Joining or becoming a user of an environment refers to setting up an account, and/or obtaining a user name and password. Environment refers to a computer-based environment in which a user can join or become a member. Such environments include social networking environments, e-commerce environments, and any hybrids thereof. A new user is one that has joined the social network and/or website within a certain time period. As such, the methods involve comparing the time period in which the poster has joined the environment, with that of a set time period designated by the site. Depending on the traffic of the site, and that can range from about 1 hour to about 1 year (e.g., hours, days, weeks, and months). If the user is not new (e.g., does not meet this criterion), the media is moved to the bottom of the ranking (e.g., receive a low ranking). In the event that the media has been moved once, the media is displayed.

The diversity algorithm based on the newness of the poster for this embodiment as applied to an image, is as follows:

### 1. For each Image i in the decreasing order of ranking

### 2. If the poster of the Image is new, display it.

### 3. If the poster of the Image is not new, move it to the bottom of the ranking.

### 4. If the Image has already been moved once, display it.

Additionally, the present invention includes methods that rank media for each poster. Each poster can have a variety of media for viewing by others, and the media can be ranked for that poster according to the methods described herein. Media, in one embodiment, is viewed according to popularity and popular Images are given extra heavy boosts (creating layers) in our rank measurement.

The present invention relates to a system or computer apparatus for ranking and providing a display of media according to its rank. The system includes a source of media and user generated/inputted data including metadata. As stated herein, the source of user generated data includes the data along with information about the object or media to which it is attached or associated. A processor which is coupled to the source, calculates one or more functions in accordance with the discovery methods described herein, and sums the results of the functions according to the weighted formula. An output device (e.g., a monitor, a printer) provides the user a display of media according to the rank which reflects the sum obtained with the processor.

With respect to the diversity algorithm, the system or computer apparatus includes a source of media and user generated/inputted data including metadata. The processor compares the metadata attached to the media with a pooled set of metadata for an environment. The processor further includes the steps described herein (e.g., displaying media in the event of shared metadata and removing one or more pieces of metadata from the pool). For the methods involving a display of media ranked at least in part according to the newness of the poster, the processor carries out those steps described herein. The system further includes an output device that provides the user with a display of media in accordance with the rank with the methods carried out by the processor.

Referring to the out, the media as ranked with the methods described herein can be displayed, e.g., on a screen in the order of their ranking. They can be displayed by category, by metadata/search terms, by poster, by users (e.g., in your network), etc. In an embodiment, the media ranked by the methods of the present invention can be applied to a calendar. Media can be displayed according to the date on which the media was uploaded by the poster, wherein the media viewed for that day is ranked by the methods described herein. More specifically, a calendar can be displayed in a daily, weekly or monthly format, with one or more media images displayed for each day, week or month, respectively. The image displayed for that time increment can be ranked by the methods described herein, and then once viewed, another image for that time increment is displayed.

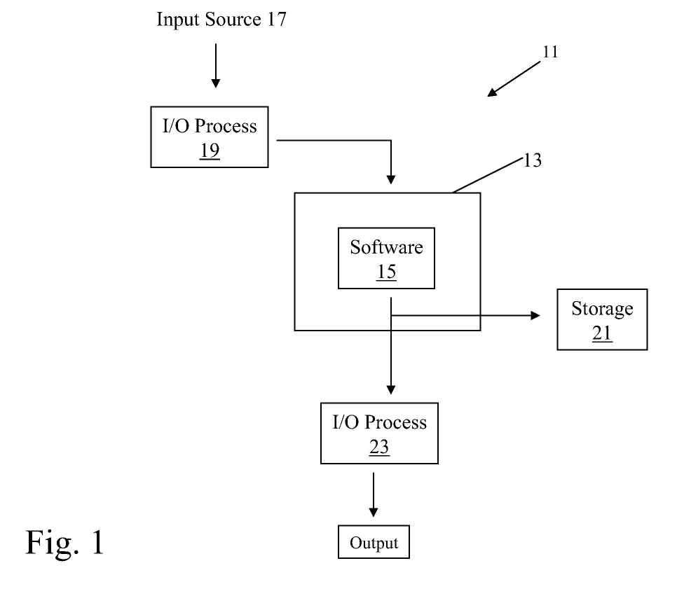

Referring to FIG. 1, a computer system embodying a software program 15 (e.g., a processor routine) of the present invention is generally shown at computer system 11. The computer system 11 employs a host processor 13 in which the operation of software programs 15 are executed (e.g., a program that allows for the steps of the methods described herein to be carried out). An input device or source such as on-line data or a database of stored user-inputted data and the like provides input to the computer system 11 at 17. The input can be pre-processed by I/O processor 19 which queues and/or formats the input data, if necessary, as needed. The user inputted data is then transmitted to host processor 13 which processes the data through software 15. Using the input data, software 15 provides an output for either memory storage 21 or display through an I/O device, e.g., a work-station display monitor, a printer, and the like. I/O processing (e.g., formatting) of the content is provided at 23 using techniques common in the art.

### Exemplification

The following discovery algorithm was used to rank and display images. The following weighted formula was used to rank images:

DR=W1(P)+W2(R)+W3(C)+W4(FB)+W5(LB)+W6(RB)−W7(BP)+W8(EB)

### W1=0.25, W2=5, W3=10, W4=3, W5=3, W6=0.1, W7=30, and W8=15.

The variables are defined as follows:

P(Popularity)=log(# of views+1)+0.1*log(# of its tag clicks in last 24 hours+1)

R(Recency)=1/sqr(# of days from the uploaded date to today)

C(Content)=log(# of comments+1)+0.3*log(# of tags+1)+0.1*log(size of the photo file in Mega bytes+1)

FB(Friend Boost)=friend photo (1 if one is the poster's friend, 0 otherwise)+friend permission (1 if the photo has a “friend” permission and one is the poster's friend, 0 otherwise)

LB(Location Boost)=2 if one lives in the same city with the poster, 1 if one lives in the same state with the poster, or 0 otherwise.

RB(Random Boost)=a random number between 0 and 1

BP(Blacklist Penalty)=# of offending tags associated with the photo

EB(Editorial Boost)=1 if an editor picks it 0 otherwise.

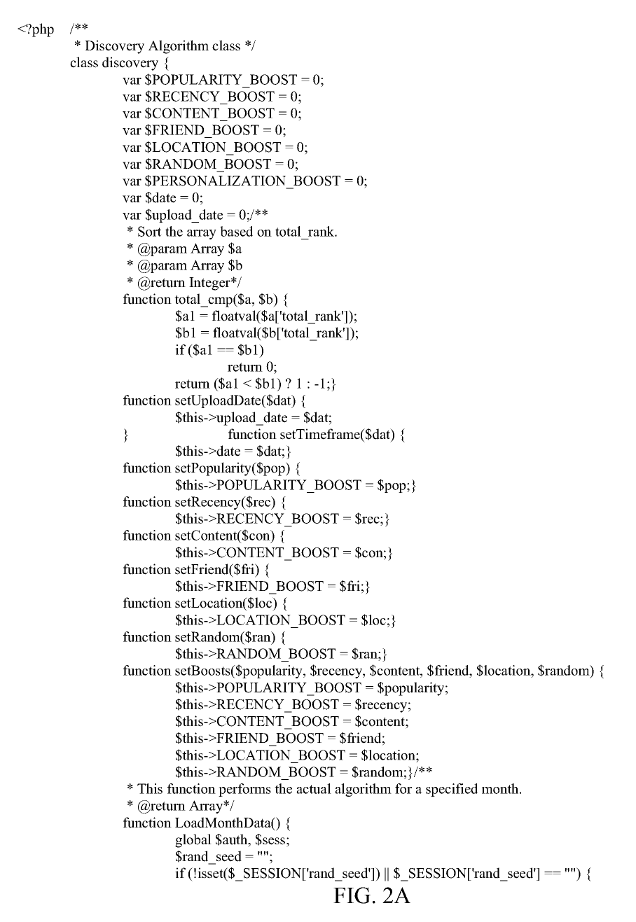

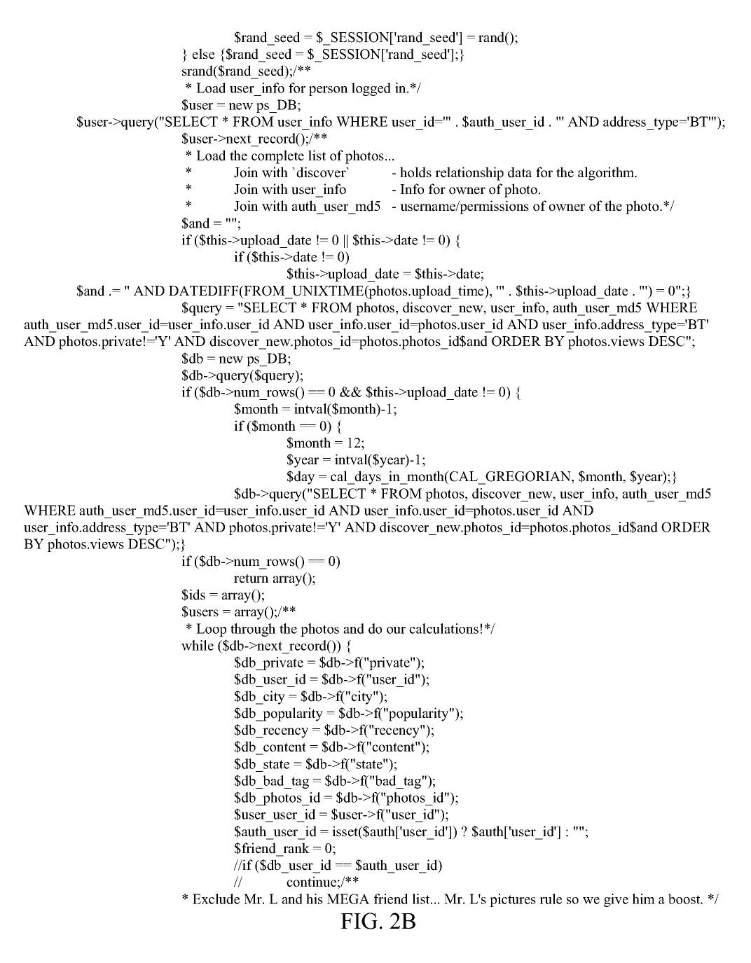

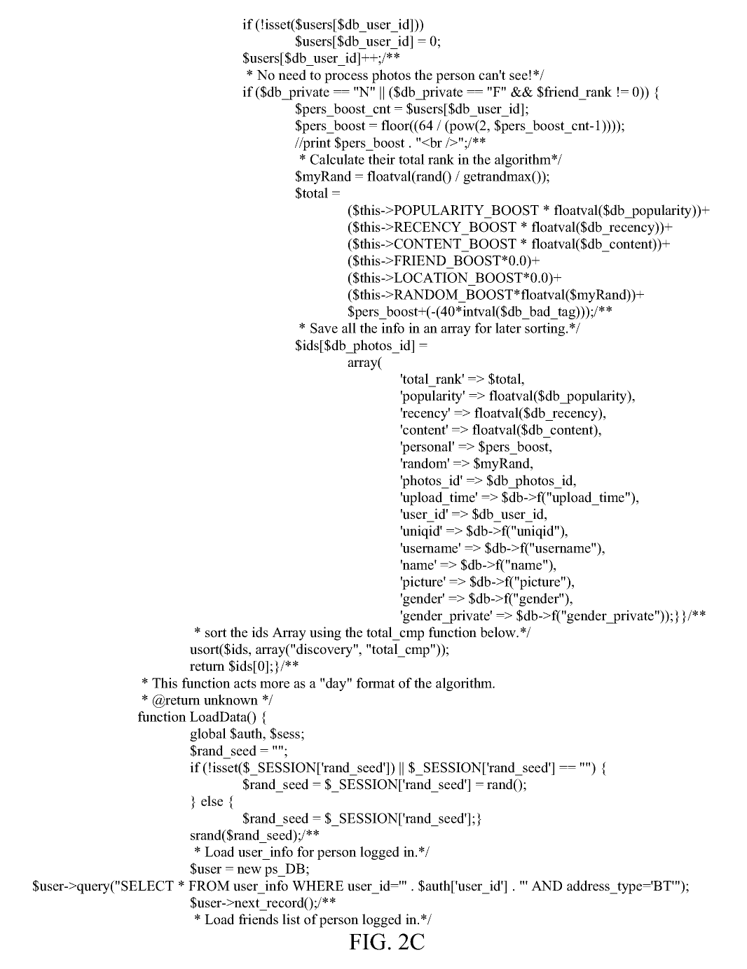

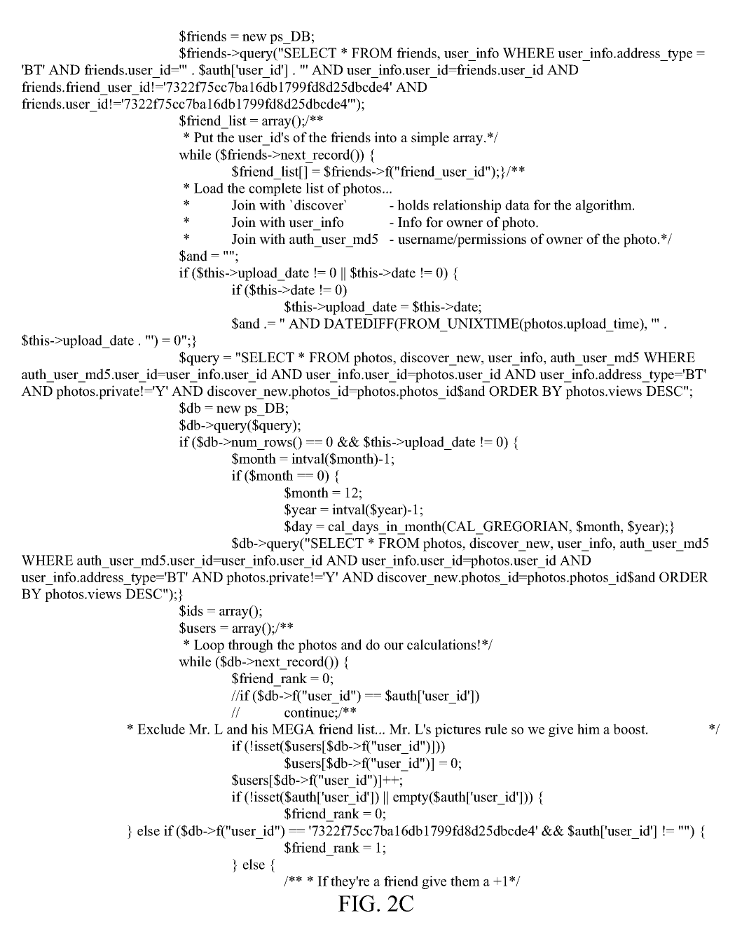

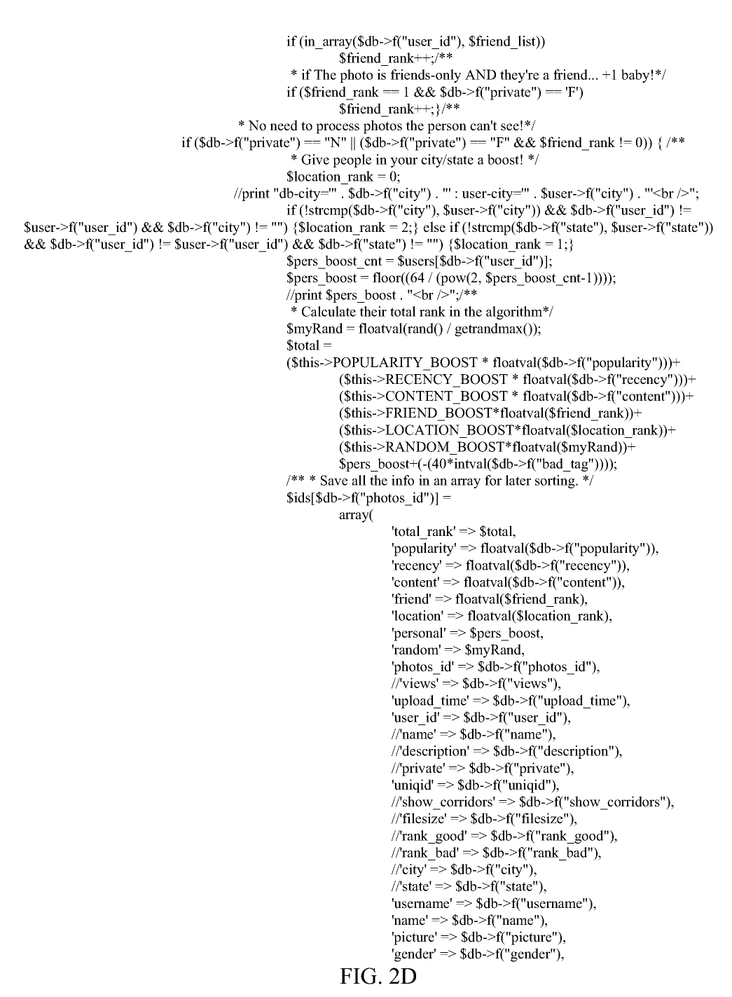

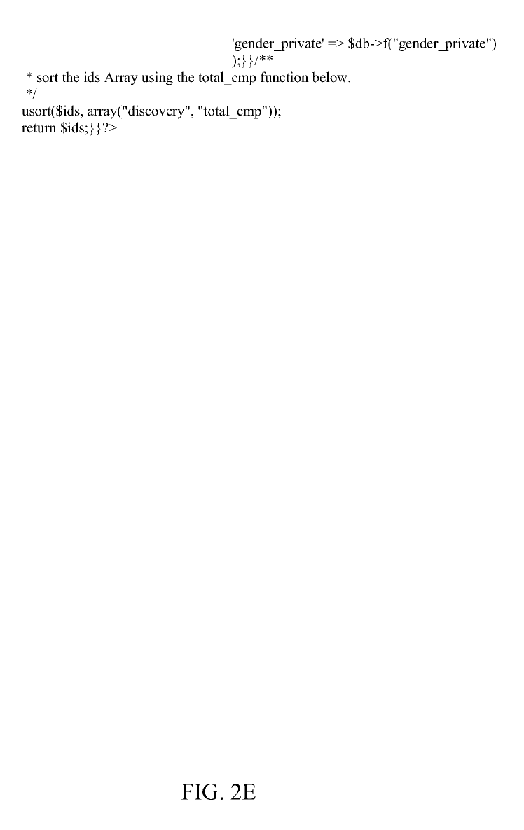

The source code for an embodiment of the discovery algorithm that was carried out is found in FIGS. 2A-E.

### Diversity:

The following Diversity algorithm was used to rank images on the same website. Set A is defined as a set containing all existing tags in the system and an Image i has a set of tags defined as set Bi.
1. For each Image i in the decreasing order of ranking
2. If the Image has no tags (i.e., Bi is empty), display it.
3. If the Image has tags and there are tags shared between A and Bi, display it and remove the most clicked shared tag from A.
4. If the Image has tags and there are no tags shared between A and Bi, move it to the bottom of the ranking.
5. If the Image has already been moved once, display it.
   Images were also ranked according to the newness of the poster as follows:

### 1. For each Image i in the decreasing order of ranking

### 2. If the poster of the Image is new, display it.

### 3. If the poster of the Image is not new, move it to the bottom of the ranking.

### 4. If the Image has already been moved once, display it.

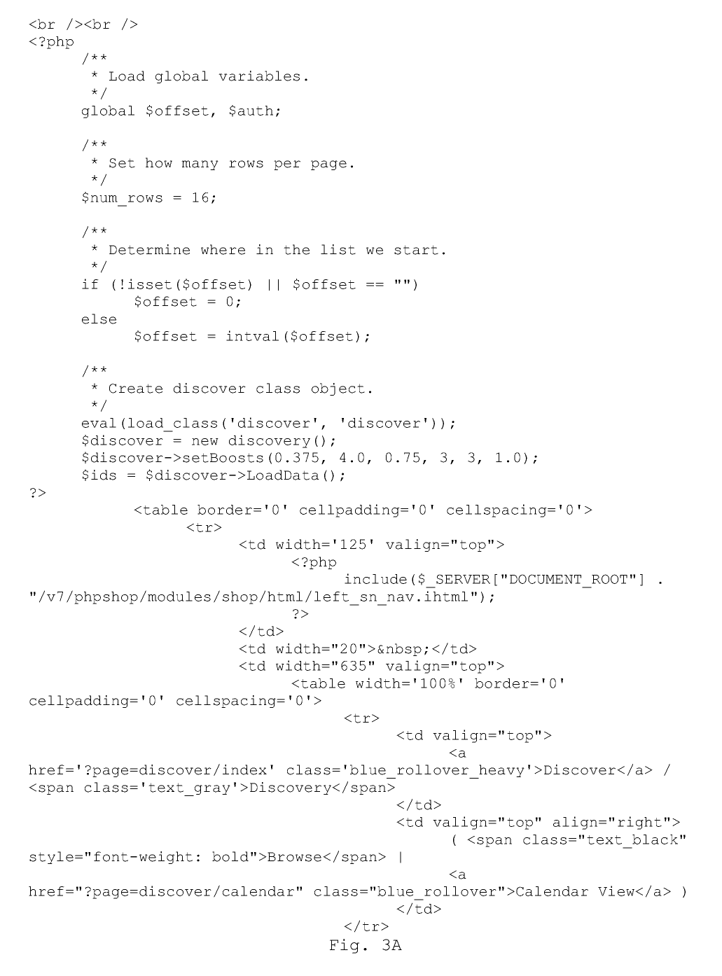

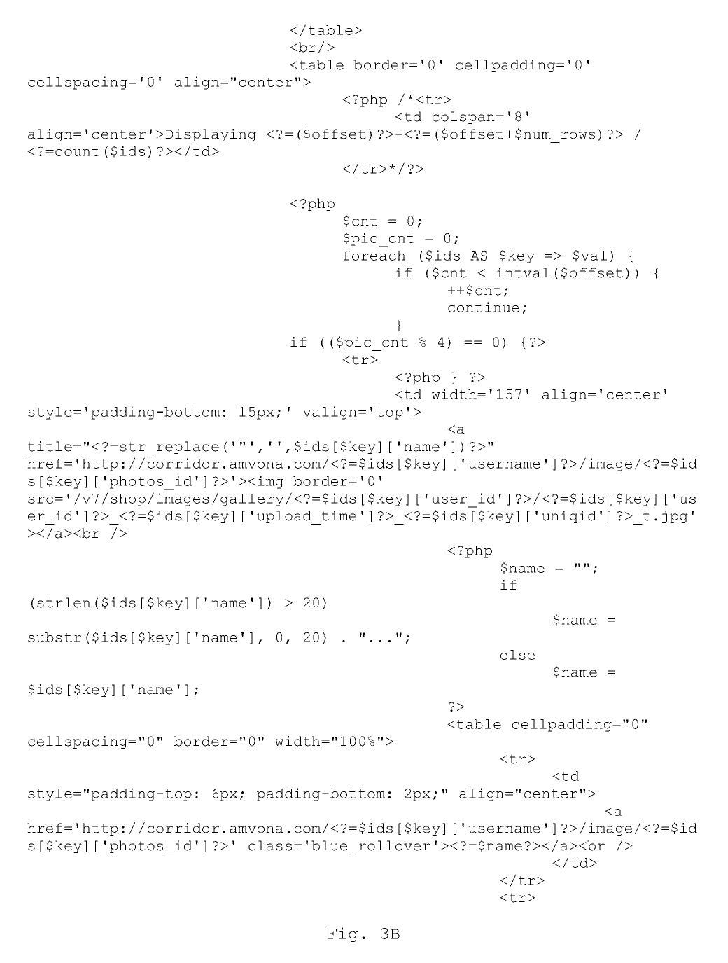

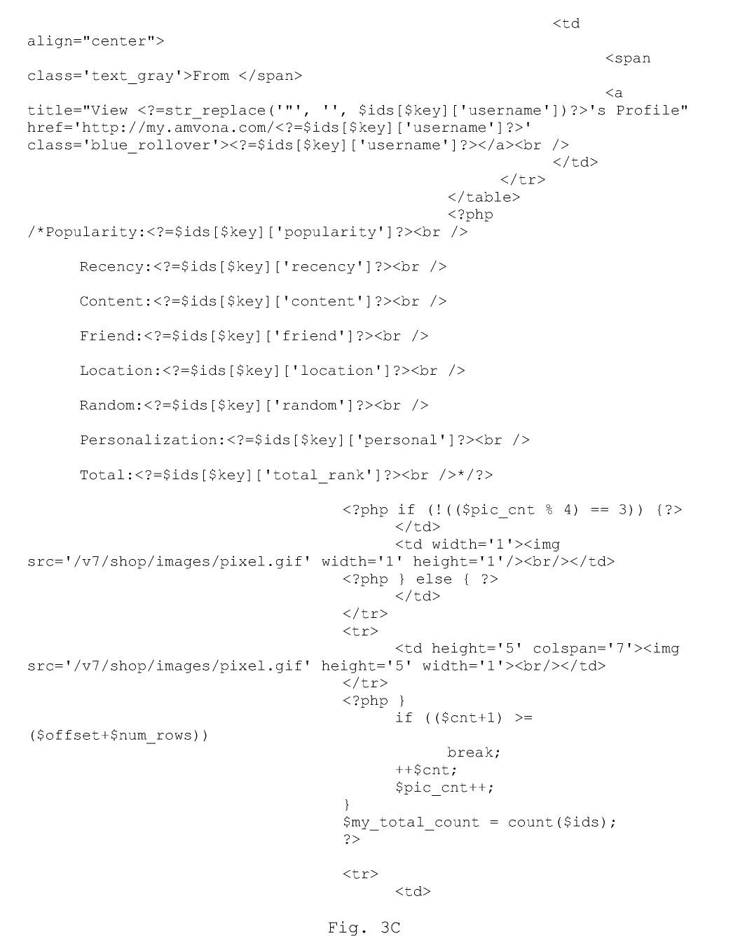

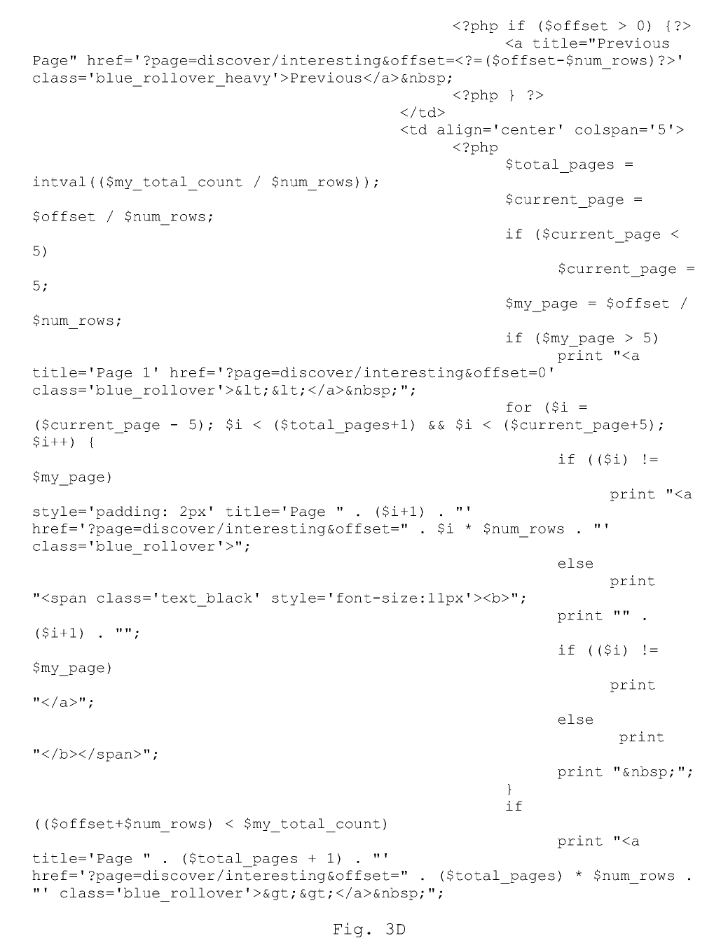

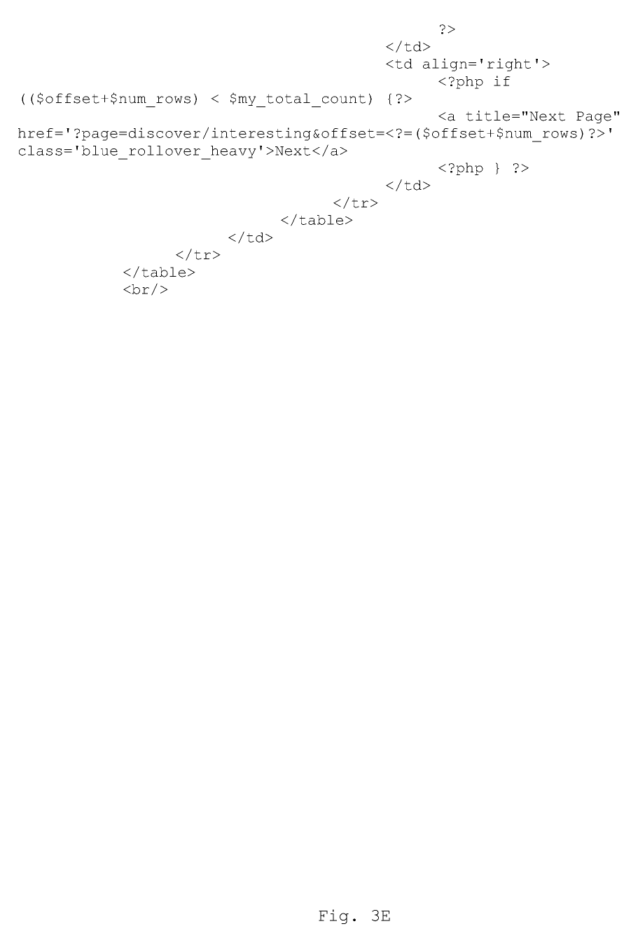

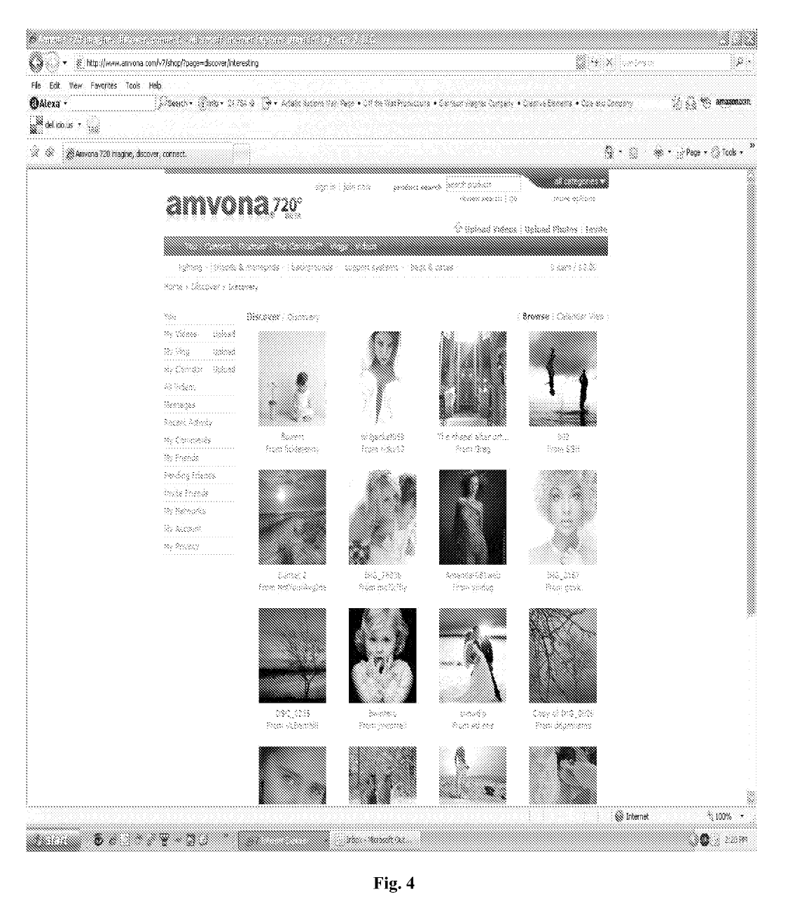

The source code, for an embodiment, for ranking the front end view of photographs is shown in FIGS. 3A-E. The display generated by the source code shown in FIGS. 3A-E is shown in FIG. 4.

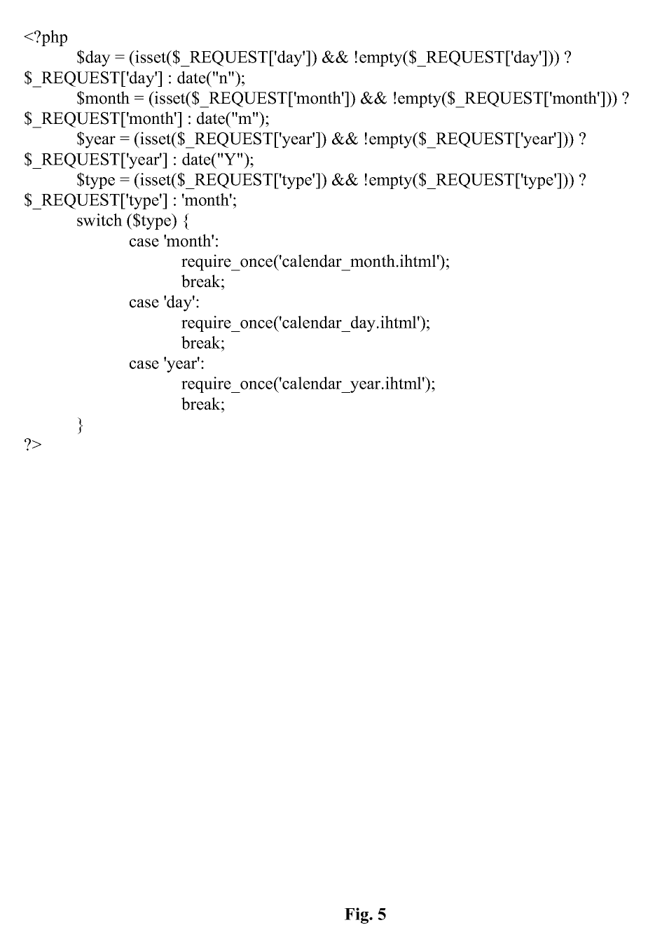

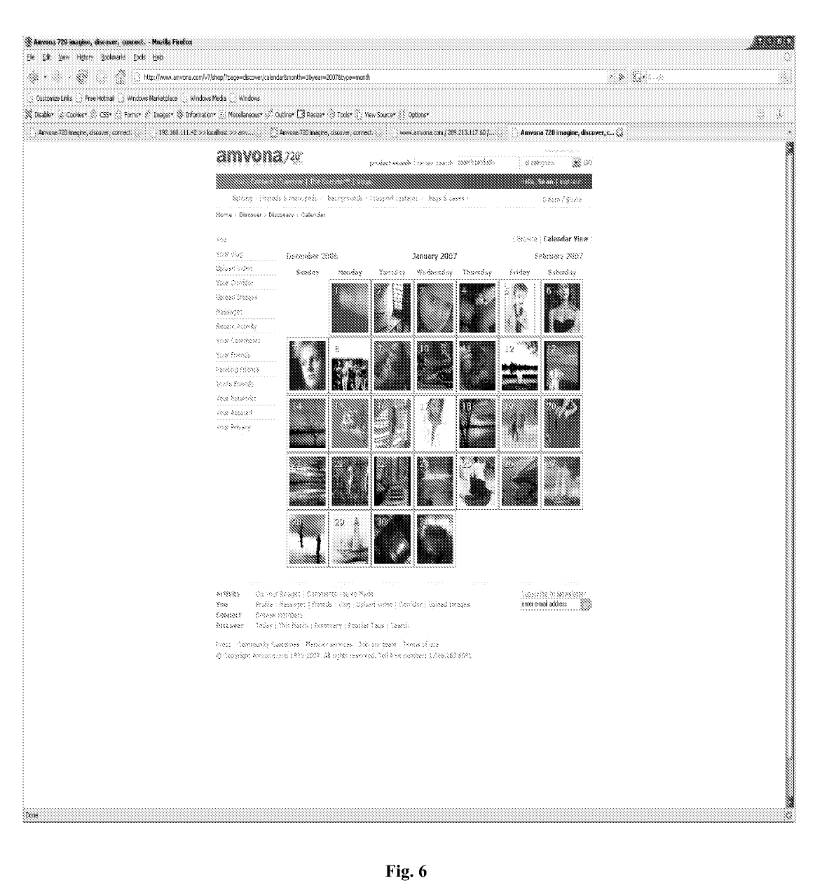

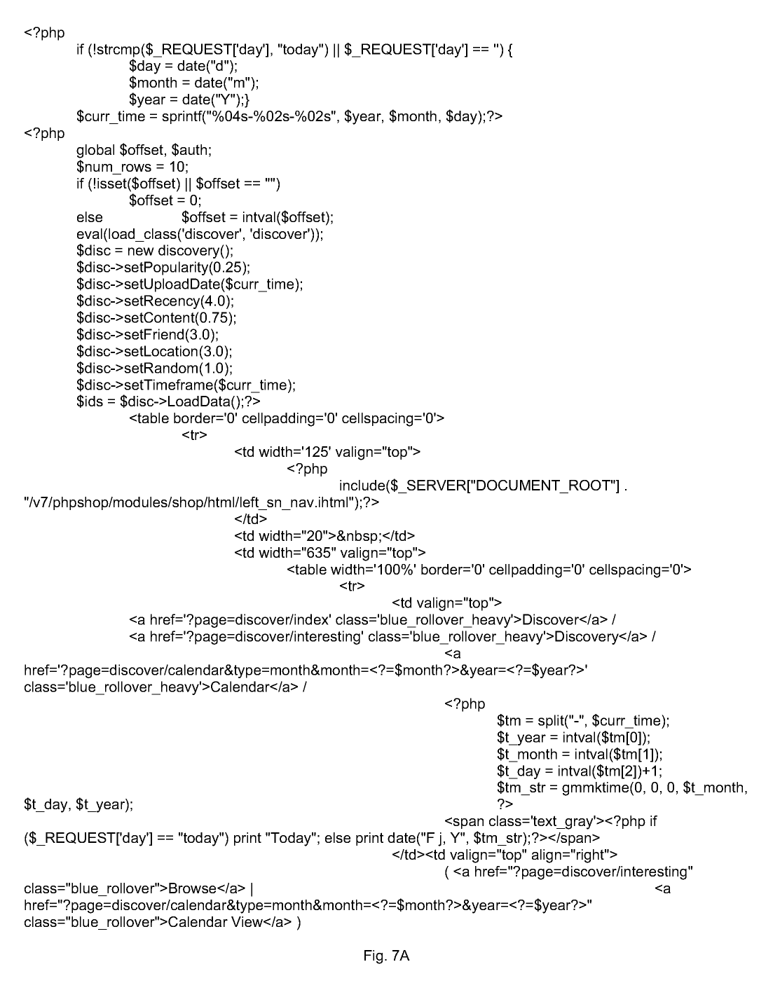

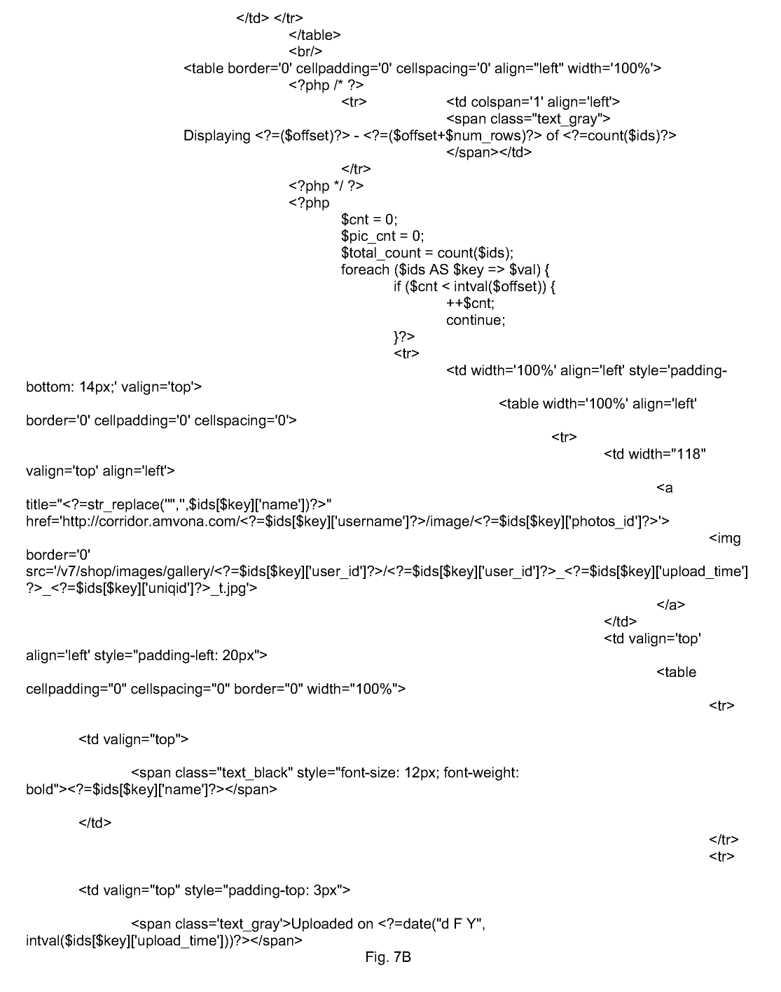

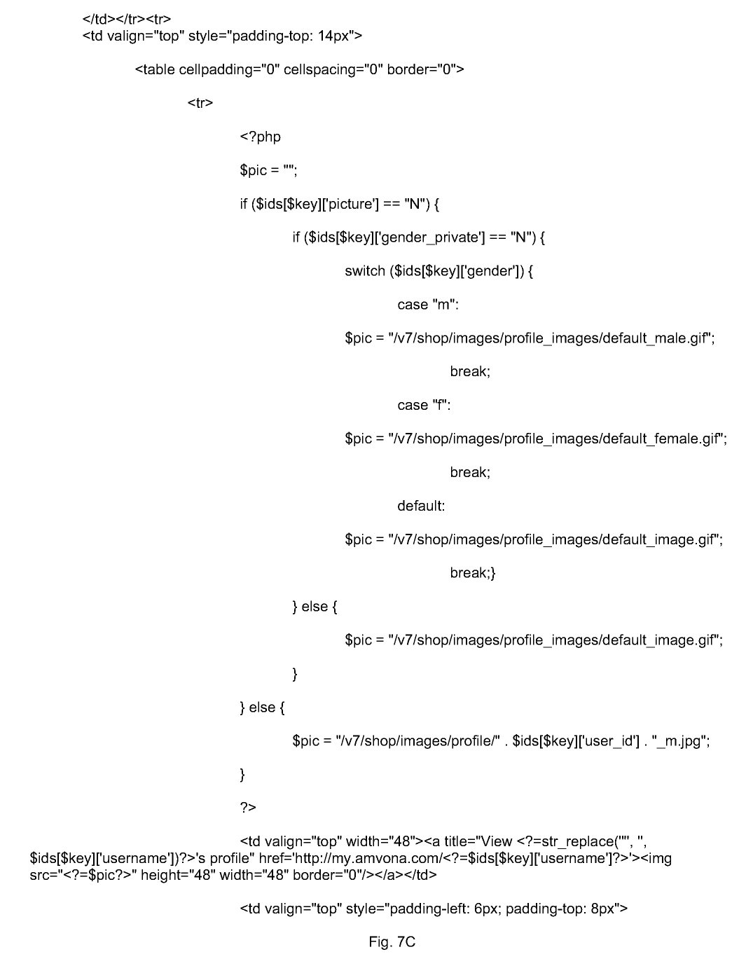

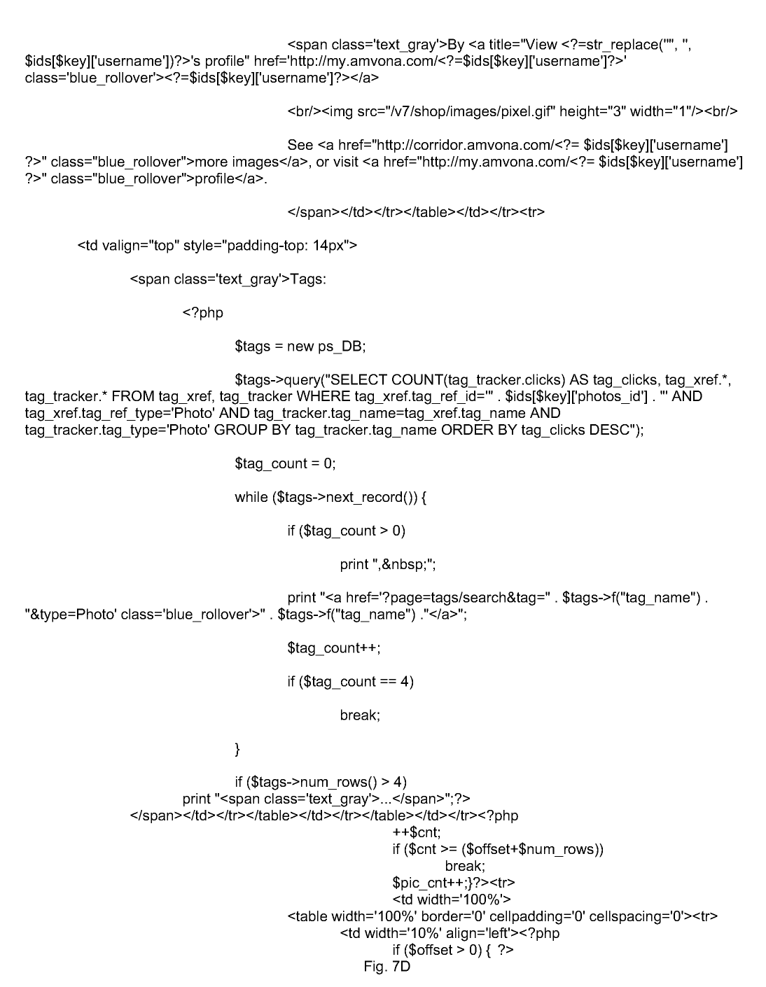

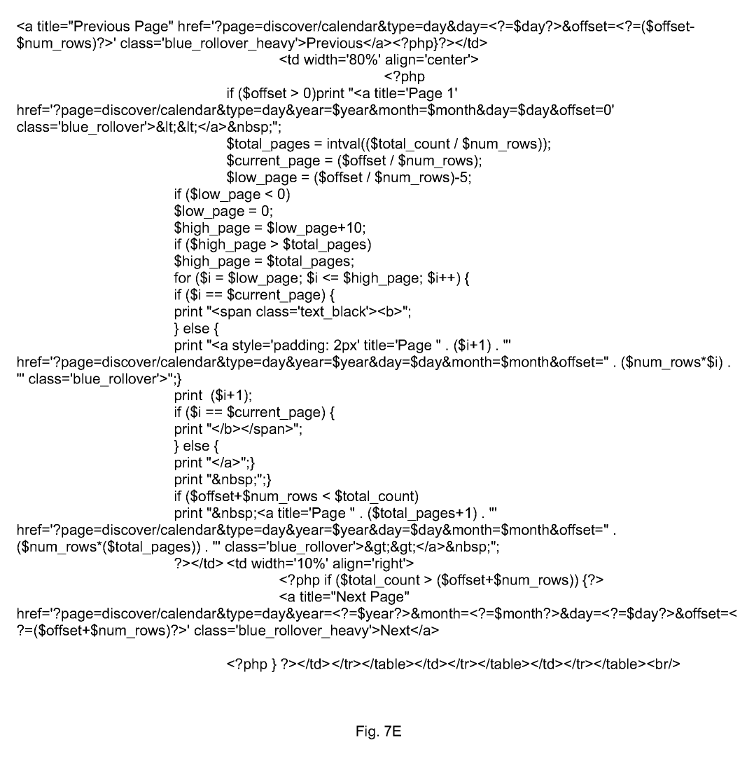

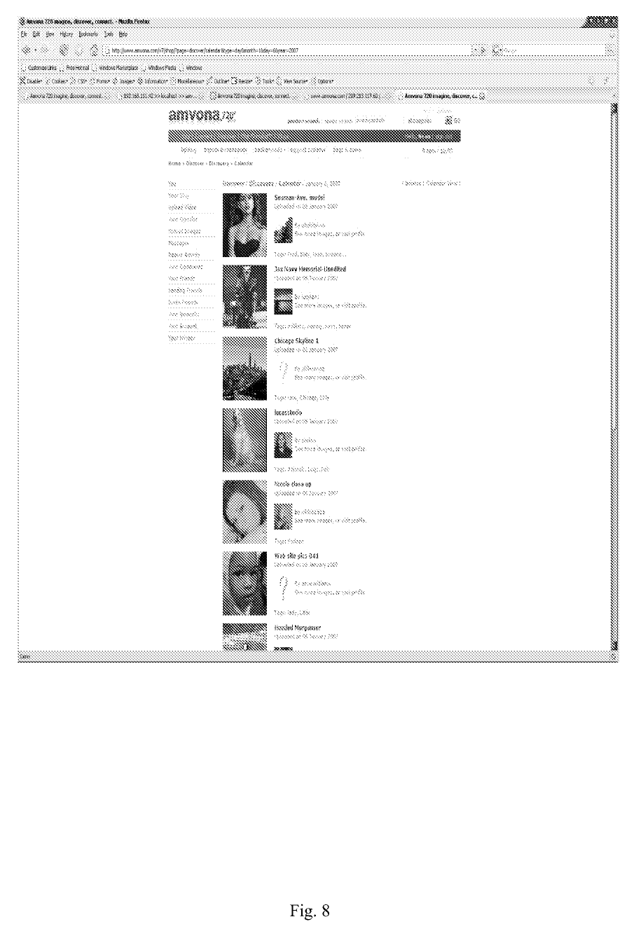

As described herein, photographs were displayed in calendar format. Photographs for monthly views were ranked according to the source code in FIG. 5, and the display generated from this source code can be viewed in FIG. 6. Similarly, photographs for daily views were ranked according to the source code shown in FIGS. 7A-E, and a sample display from a particular day is shown in FIG. 8.

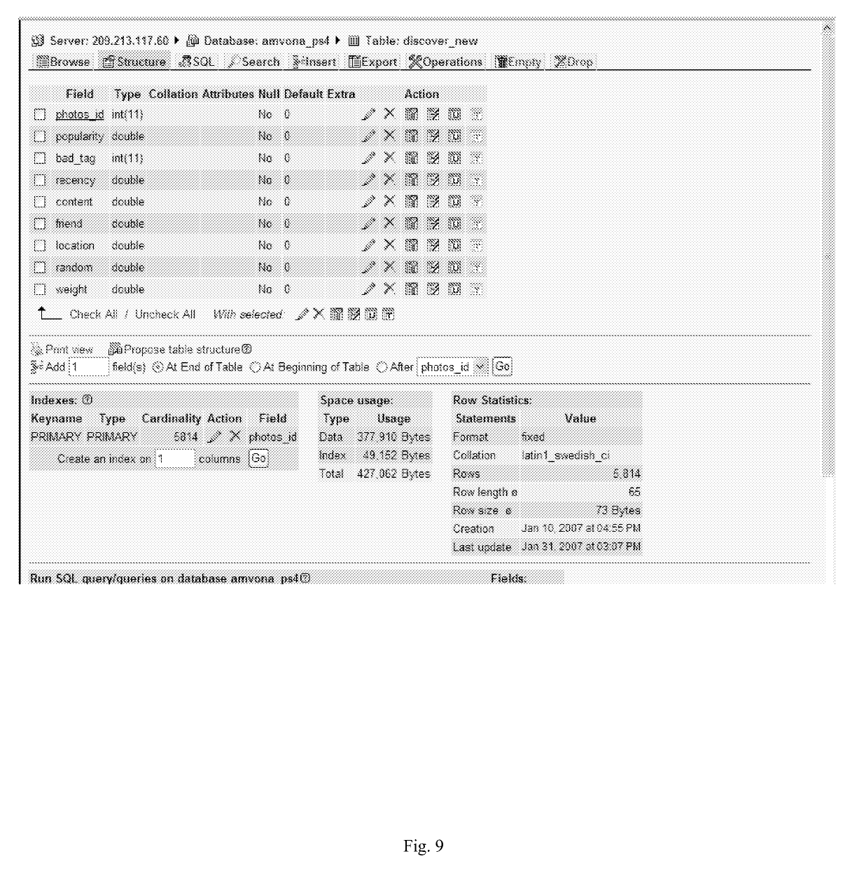

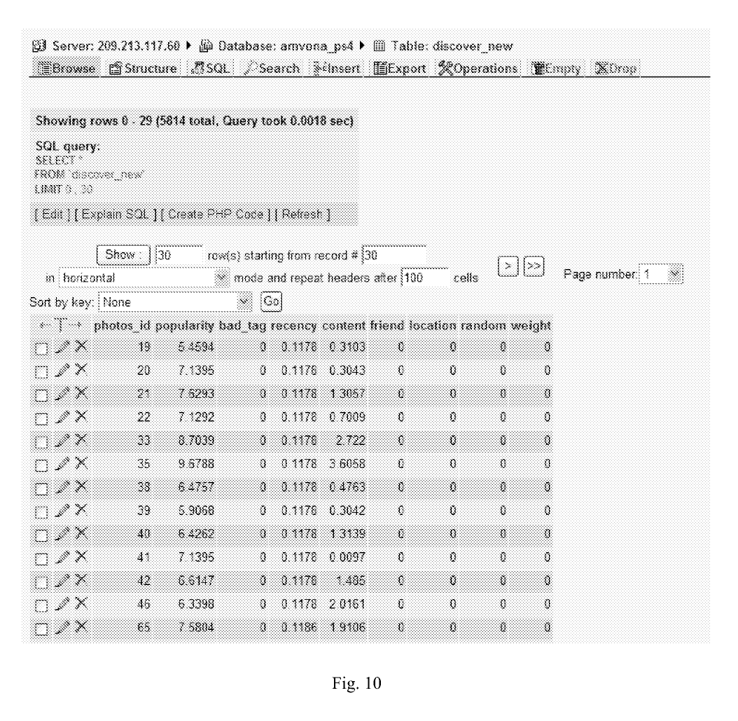

The structure of the database and actual variable amounts when executing the discovery algorithmare shown in FIGS. 9 and 10, respectively.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of ranking one or more media in an environment for display by a user, wherein the media is uploaded by a poster; the methods comprises:
a. calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB), to obtain a result for each variable calculated; and
b. summing said one or more results with a weighted formula to thereby obtain a sum;
wherein the rank of the media is a function of the sum.

2. The method of claim 1, further including calculating a function based on a number of offending metadata attached to the media, to thereby obtain a blacklist penalty (BP), and subtracting the blacklist penalty from the sum.

3. The method of claim 2, further including calculating a function based on an editor's opinion of the media (Editor's Boost (EB)), and adding result to the sum.

4. The method of claim 3, wherein the sum is obtained by a weighted formula that comprises:
Sum=W1(P)+W2(R)+W3(C)+W4(FB)+W5(LB)+W6(RB)−W7(BP)+W8(EB)
wherein W1, W2, W3, W4, W5, W6, W7, and W8 is a number, wherein the greater the number the greater the weight of the variable, and the lesser the number the lesser the weight of the variable.

5. The method of claim 4, wherein said one or more functions are calculated using the following formulas:
P=log(# of views+1)+0.1*log(# of its tag clicks in last 24 hours+1);
R=1/sqr(# of time increments from the uploaded date to today);
C=log(# of comments+1)+0.3*log(# of tags+1)+0.1*log(size of the media file in Mega bytes+1);
FB=(1 if user is the poster's network, 0 otherwise)+(1 if the media has permission for view by poster's network and user is in poster's network, 0 otherwise);
LB=2 if user lives in the same city with the poster, 1 if one lives in the same state with the poster, or 0 otherwise;
RB=a random number between 0 and 1;
BP=# of offending tags attached to with the media; and
EB=1 if an editor's pick, 0 otherwise.

6. The method of claim 1, wherein steps of the methods are applied to media uploaded for a specific date, week, month or year.

7. The method of claim 6, wherein the media is displayed in a calendar format.

8. A method of ranking one or more media in an environment for display by a user, wherein the media is uploaded by a poster; the methods comprises:
a. calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB), to obtain a result; wherein said one or more functions are calculated using the following formulas:
P=log(# of views+1)+0.1*log(# of its tag clicks in last 24 hours+1);
R=1/sqr(# of time increments from the uploaded date to today);
C=log(# of comments+1)+0.3*log(# of tags+1)+0.1*log(size of the media file in Mega bytes+1);
FB=(1 if user is the poster's network, 0 otherwise)+(1 if the media has permission for view by poster's network and user is in poster's network, 0 otherwise);
LB=2 if user lives in the same city with the poster, 1 if one lives in the same state with the poster, or 0 otherwise; and
RB=a random number between 0 and 1; and
b. summing said one or more results with a weighted formula to thereby obtain a sum, wherein the weighted formula comprises:
W1(P)+W2(R)+W3(C)+W4(FB)+W5(LB)+W6(RB);
wherein W1, W2, W3, W4, W5, and W6, is a number, wherein the greater the number the greater the weight of the variable, and the lesser the number the lesser the weight of the variable, wherein the rank of the media is a function of the sum;
c. displaying the one or more media according to rank.

9. The method of claim 8, further comprising:
a. calculating a function based on a number of offending metadata attached to the media, to thereby obtain a blacklist penalty (BP), and subtracting the blacklist penalty from the sum; and
b. calculating a function based on an editor's opinion of the media (Editor's Boost (EB)), and adding result to the sum.

10. A method of displaying one or more media having metadata attached thereto, wherein the metadata from more than one piece of media in an environment is pooled to thereby obtain a pooled set of metadata; wherein the one or more media has a rank; the method comprises:
a. comparing the metadata attached to the media with the pooled set of metadata to determine if shared metadata exists; and
b. if shared metadata exists, the method comprises:
(1) displaying said media having the attached metadata; and
(2) removing one or more pieces of shared metadata from the pooled set;
if no shared metadata exists, the method comprises assigning a rank to the media, wherein the rank is a low rank;
wherein said media is displayed according to rank.

11. The method of claim 10, further including displaying the media if said media has received a change in rank.

12. The method of claim 10, wherein removing one or more pieces of metadata includes removing a piece of metadata that is popular.

13. The method of claim 12, wherein a popular piece of metadata is a piece of metadata having the most number of views or click in a time period.

14. The method of claim 10, where removing one or more pieces of metadata includes removing all pieces of metadata that is shared with the pooled set.

15. A method of displaying one or more media based on the presence, absence or content of metadata attached to the media, wherein the metadata from more than one piece of media in an environment is pooled to thereby obtain a pooled set of metadata; wherein the one or more media has a rank; the method comprises:
a. if said media has an absence of metadata attached thereto, or has received a change in rank, displaying the media;
b. if said media has metadata attached thereto; the method includes comparing the metadata attached to the media with the pooled set of metadata to determine if shared metadata exists;
i. if shared metadata exists, the method comprises:
(1) displaying said media having the attached metadata; and
(2) removing one or more pieces of metadata from the pooled set;
ii. if no shared metadata exists, the method comprises assigning a rank to the media, wherein the rank is a low rank;
wherein said media is displayed according to rank.

16. A method of displaying one or more media uploaded from a poster, wherein the poster is part of a social network environment, wherein a poster that has joined the social network environment within a time period, and wherein the one or more media has a rank; the method comprises:
a. comparing the time period in which the poster has joined the social network environment to a set time period; and
b. if the time period in which the poster has joined the social network environment is less than or equal to the set time period, then displaying the media;
c. if the time period in which the poster has joined the social network environment is greater than the set time period, then assigning a rank to the media, wherein the rank is a low rank;
wherein said media is displayed according to rank.

17. The method of claim 16, further including displaying the media if said media has received a change in rank.

18. A method of ranking one or more media in an environment for display by a user, wherein the media is uploaded by a poster; the methods comprises:
a. calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB), to obtain a result; and
b. summing said one or more results with a weighted formula to thereby obtain a sum, wherein the rank of the media is a function of the sum;
c. displaying one or more media based on metadata attached to the media, wherein the metadata from more than one piece of media in an environment is pooled to thereby obtain a pooled set of metadata; wherein the one or more media has a rank; the step of displaying the one or more media comprises:
i. comparing the metadata attached to the media with the pooled set of metadata to determine if shared metadata exists; and
ii. if shared metadata exists, the method comprises:
(1) displaying said media having the attached metadata; and
(2) removing one or more pieces of metadata from the pooled set;
if no shared metadata exists, the method comprises assigning a rank to the media, wherein the rank is a low rank;
wherein said media is displayed according to rank.

19. A system for providing a display of one or more media, the system comprises;
a. a source of the media in an environment for display by a user, wherein the media is uploaded by a poster;
b. a processor, coupled to the source, wherein the processor carries out the steps that comprise:
i. calculating one or more functions, based on a random variable (Random Boost (RB)) and one or more variables selected from the group consisting of popularity (P) of the media, recency (R) of the upload of the media, content (C) of the media, user's relationship to the poster (Friend Boost (FB)), and user's location in relation to the poster (Location Boost (LB), to obtain a result; and
ii. summing said one or more results with a weighted formula to thereby obtain a sum; and
c. an output device that provides a display of the media according to a rank, wherein the rank of the media is a function of the sum.

20. A system for providing a display of one or more media by a user, the system comprises;
a. a source of one or more media having metadata attached thereto, wherein the metadata from more than one piece of media in an environment is pooled to thereby obtain a pooled set of metadata; wherein the one or more media has a rank;
b. a processor, coupled to the source, wherein the processor carries out the steps that comprise:
i. comparing the metadata attached to the media with the pooled set of metadata to determine if shared metadata exists; and
ii. if shared metadata exists, the method comprises:
(1) displaying said media having the attached metadata; and
(2) removing one or more pieces of metadata from the pooled set;
if no shared metadata exists, the method comprises assigning a rank to the media, wherein the rank is a low rank; and
c. an output device that provides a display of the media according to rank.

21. A system for providing a display of one or more media by a user, the system comprises;
a. a source of one or more media uploaded by a poster, wherein the poster is part of a social network environment, wherein a poster that has joined the social network environment within a time period, and wherein the one or more media has a rank;
b. processor, coupled to the source, wherein the processor carries out the steps that comprise:
i. comparing the time period in which the poster has joined the social network environment to a set time period; and
ii. if the time period in which the poster has joined the social network environment is less than or equal to the set time period, then displaying the media;
iii. if the time period in which the poster has joined the social network environment is greater than the set time period, then assigning a rank to the media, wherein the rank is a low rank; and
c. an output device that provides a display of the one or more media according to rank.
